(19) United States
(12) Patent Application Publication
(10) Pub. No.: US 2006/0120955 A1
(43) Pub. Date: Jun. 8, 2006

(54) PARTICLES, SENSOR USING PARTICLES AND METHOD FOR PRODUCING POROUS STRUCTURE UNIT

(75) Inventor: Hirokatsu Miyata, Hadano-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/275,065

(22) Filed: Dec. 7, 2005

(30) Foreign Application Priority Data
Dec. 8, 2004 (JP) 2004-355465

(51) Int. Cl. C01B 39/04; C01F 7/00

(52) U.S. Cl. 423/702

(57) ABSTRACT

A particle having a large amount of biosubstances per unit volume has been needed for application to biosensors and the like. Accordingly, the present invention provides the particle comprising mesopores in which biosubstances are held and having a diameter ten times or less as large as the diameter of the mesopores.

### BACKGROUND OF THE INVENTION

1. Field of the Invention

The present invention relates to particles which hold biological materials in mesopores. In particular, by detecting a specific biological substance using the particles, the present invention may be applied to a sensor and the like, for diagnosis of diseases such as cancer.

2. Related Background Art

Since the technology of fixing biomaterials, in particular biomolecules, on an insoluble carrier can be applied to a biocatalyst for bioproduction, a detection device for biosubstances and the like, this technology has been developed actively at present time. In particular, the technology of carrying out the antigen-antibody reaction, which is based on the highly advanced molecular recognition reaction, outside the cell is very important for diagnosis of diseases and the like. However, the three dimensional structure of protein is directly related to its function, and in particular, intracellular proteins tend to change the three dimensional structure outside the cells and consequently frequently lose the functions expressed in the cells. This is a big problem for developing a device using protein, and the technology of fixing proteins on a carrier stably while maintaining the activity of the protein, that is, maintaining the three dimensional structure is very important.

One of the technologies of fixing proteins is to use micro-space of porous materials. This technology uses inorganic materials prepared by sol-gel method, mesoporous silica, porous organic polymer, porous silicon, porous glass and the like. Further, Japanese Patent Application Laid-Open No. 2004-83501 discloses a technology of using mesoporous silica to carry an antibody, and Japanese Patent Application Laid-Open No. 2000-139459 discloses a technology for immobilizing several enzymes on mesoporous silica.

On the other hand, preparation of very fine particles of mesoporous silica with relatively even particle diameter has been reported in Journal of the American Chemical Society Vol. 126, 462. In this method, the synthesis is carried out using combination of a nonionic surfactant and a cationic surfactant.

However, in the technologies described above, following several points need to be improved.

The mechanical strength of porous organic polymers is not strong enough in some cases. Porous silicon is not transparent and thus it is difficult to confirm the immobilization of biomolecules optically.

With regard to these points, mesoporous silica is an advantageous host material, but there are problems in the size and the arrangement of their pores. In many cases, the pore size of mesoporous silica is too small compared to the size of biomaterials. As to the arrangement of the tubular pores, the small number of the pore openings exposed to the outer surface makes it difficult to increase the amount of biomaterials immobilized on the mesoporous silica. In the case of three-dimensional fine pores, such as cubic structure, the small windows connecting between the spherical mesopores is disadvantageous for facile diffusion of biomaterials inside the mesopores.

Therefore, there has been a demand for a porous material, which allows accommodation of a large amount of biomaterials per unit volume, with enough mechanical strength, chemical stability and optical transparency.

Thus, an objective of the present invention is to provide a porous material that can accommodate a large amount of biomaterials per unit volume.

### SUMMARY OF THE INVENTION

The present invention provides particles which include mesopores holding a biosubstance, the particles having a diameter ten times or less as large as the diameter of the mesopores.

Further, the present invention provides a sensor for detecting a substance, comprising particles which include mesopores holding a biosubstance, the particles having a diameter ten times or less as large as the diameter of the mesopores, and a detection part that detects a reaction forming a bond between the substance to be detected and the biosubstance when the reaction takes place.

Still further, the present invention provides a method for producing a porous structure unit comprising:

a step of preparing an aqueous solution containing a cationic surfactant, a nonionic surfactant, and a hydrophobic material that swells the micelles;

a step of forming a mesostructure of silica having the surfactant and the hydrophobic material by adding a silica source to the aqueous solution;

a step of removing the surfactant and the hydrophobic material from the structure to make the structure hollow; and

a step of immobilizing a biosubstance, which forms a selective bond with a biomaterial to be detected, inside the hollow mesopores in the structure.

Furthermore, the present invention provides a method for producing particles, comprising:

a step of preparing a solution containing a cationic surfactant and a nonionic surfactant;

a step of forming particles containing the surfactant by adding a silica source to the solution;

a step of forming particles having mesopores by removing the surfactant from the particles; and

a step of immobilizing a biosubstance in the mesopores.

According to the present invention, the number of the pore opening per unit volume is increased, and it become possible to provide particles that can accommodate a large amount of biosubstances per unit volume, and to provide a sensor having high sensitivity that can be applied to diagnosis for diseases such as cancer and the like.

### BRIEF DESCRIPTION OF THE DRAWINGS

FIG. 1 is a schematic illustration of mesoporous silica of the present invention, on which mesoporous silica the site for the selective reaction for biosubstances is composed;

FIG. 2 is a schematic diagram of the reaction vessel for holding mesoporous silica and for carrying out the reaction of biosubstances in vitro;

FIG. 3 is a schematic drawing of an artificial antibody that is produced in Example 2 of the present invention;

FIG. 4 is a schematic illustration of the reactor part of the biosensing device that is used in Example 3 of the present invention; and

FIG. 5 is a schematic diagram of the detector part of the biosensing device that is used in Example 3 of the present invention.

### DESCRIPTION OF THE PROFFERED EMBODIMENTS

Following is the detailed description of the present invention.

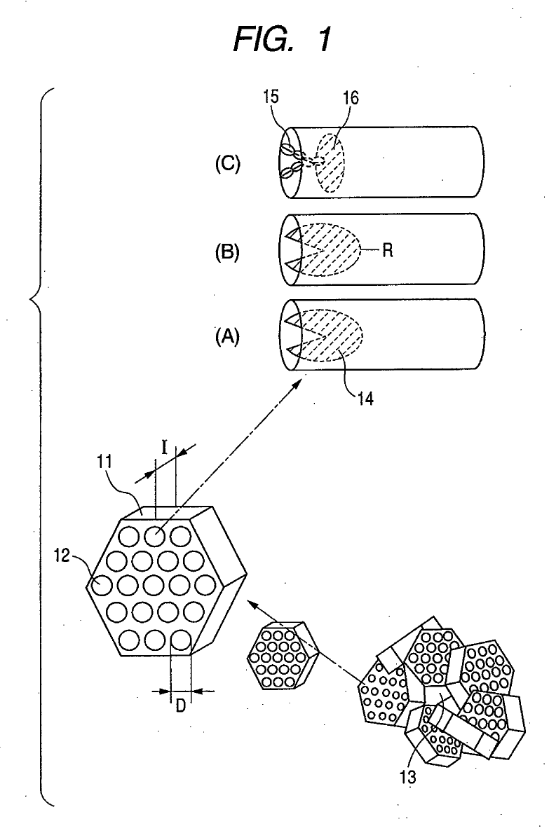

FIG. 1 is a schematic drawing of the materials of the present invention.

First, the porous material that is used in the present invention is explained. Porous silica particles 11 used in an embodiment according to the present invention are particles of mesoporous silica, that are produced by using assemblies of a surfactant as templates, with fine pores 12 with a substantially uniform diameter D. This drawing depicts a porous structure of which tubular shaped fine pores are honeycomb-packed. However, the structure of the fine pores is not limited to this structure, and various structures such as a structure in which spherical fine pores are packed in three dimensions, fine pores with a double gyroid structure and the like, can be applied to the present invention.

There is no limitation in the pore size of mesoporous silica to be used, but the pore size needs to be optimized for the biosubstance to be used, because if it is smaller than the size of biomaterial to be immobilized in the pores, it is difficult to introduce the biosubstance into the fine pores. The pore size of the mesoporous silica, which is prepared using a cationic surfactant, is generally in the range of 2-3 nm and this is too small for many biosubstances. In such a case, it is necessary to increase the pore size by adding an substance, that has a micelle swelling effect, to the reaction mixture. Trimethylbenzene, decane and aliphatic amines have been reported as the substances that have the micelle-swelling effect. It is needless to say that any substance that has the micelle swelling effect can be used. Further, for evaluating the pore size distribution in the mesoporous silica used in the present invention, the method for measuring the adsorption isotherms of a gas, such as nitrogen and the like, can be used. The obtained isotherms are analyzed using the method of Berret-Joyner-Halenda (BJH) and the like to estimate the pore size distribution.

In FIG. 1, hexagonal plate-like particles are depicted as primary particles of the present invention, but the shape of the primary particles itself has no significance and the primary particles of any shape, such as ball shaped, cubic shaped and the like can be used.

In the present invention, a biosubstance is immobilized in the fine pores and a biomaterial which forms a selective bond with the biosubstance is detected. In this case, it is necessary to immobilize the biosubstance on the porous silica with high density to detect the biomaterial with high sensitivity, because the biomaterial to be detected is often present in minute amount. Thus, the specific surface area of the carrier, porous silica, becomes important. In a case that a biosubstance with large size to be fixed, like in the present invention, a problem lies with diffusion in the fine pores and therefore, the aspect ratio of the fine pores and the ratio of the pore opening to the particle outer surface become important. In the conventional tube-shaped fine pores, the aspect ratio, that is the ratio I/D of the diameter D to the length I of the fine pores, is 1000 or above, while in the present invention good results are obtained by producing porous particles with very small size (length) I, that is equal to ten times or less of the diameter D of the fine pores.

Here, the technology for controlling the particle size of mesoporous silica is described. The method described in The Journal of the American Chemical Society Vol. 126, 462, may be utilized. This method uses a mixture of a cationic surfactant and a nonionic block copolymer surfactant. The cationic surfactant forms micelles in the silica mesostructure and functions as a template for the fine pores of mesoporous silica. On the other hand, the nonionic block copolymer surfactant is regarded to have a suppressive function of the growth of the silica mesostructure. The cationic surfactant to be used includes cetyltrimethyl ammonium, stearyltrimethyl ammonium and the like. As the nonionic block copolymer surfactant, polyethyleneoxide-polypropyleneoxide-polyethyleneoxide triblock polymers and the like are favorably used. However, the usable surfactant is not limited to these, and any substance may be used as long as the objective of the present invention can be achieved.

The mesoporous silica particles that are used in the present invention are basically prepared by this procedure. However, since the fine pores formed by the cationic surfactant is too small for fixing biological substances, in many cases, as described earlier, a substance having an activity of swelling micelles such as trimethylbenzene is added. By so doing, the fine particle mesoporous silica with a large pore size can be prepared. The pore size can be increased by subjecting the formed particles to the aging treatment at high temperature.

There is another advantage of using the primary particles with a small particle size. As shown in FIG. 1, aggregation of fine particles generates gaps 13. In the case of the size of the primary particles of the present invention, the gaps 13 formed between the particles are minute spaces of less than 50 nm. On fixing a biosubstance in the mesopores, the biosubstance diffuses through these spaces and reaches to mesopores to be fixed. The pores having this size play a role of stabilizing the biomaterial to be detected through the antigen-antibody reaction and the like described later, and as a result, contributes to the high detection sensitivity.

Next, the step of fixing a biosubstance to the mesoporous silica is explained.

The biosubstance to be immobilized in fine pores is to form a selective bond with the biomaterial to be detected. The biosubstance to be immobilized is not limited, but immobilizing an antibody or a fragment of an antibody for detecting a specific antigen (a biomaterial) is useful.

There are several methods for immobilizing the biomaterial 14 in the fine pores. In some cases, the biosubstance is incorporated and immobilized into the fine pores, by simply contacting the mesoporous silica with a solution containing the target biosubstance without any special treatment of the mesoporous silica ((A) of FIG. 1). Or, in some cases, the stability of the immobilized biosubstance is improved either by modifying the surface of porous silica using silane coupling agent and the like or by forming a particular functional group R in the fine pores ((B) of FIG. 1). In the present invention, the method for immobilizing biosubstances in fine pores is not limited.

However, in the cases where a substance to be immobilized is the biosubstance 15 (an antibody or a fragment thereof) and the site, to which the biomaterial to be detected is bound selectively, is restricted, the direction of the biomaterial fixed in fine pores becomes an important issue. In such cases, it is preferable to introduce a substance 16 that can be a foothold for fixing the substance (biosubstance) to be fixed in fine pores beforehand. For example, gold fine particles can be introduced into the fine pores, and by accommodating an artificial antibody that has an affinity site with gold in one terminal, it is possible to immobilize the antibody with a favorable direction ((C) of FIG. 1).

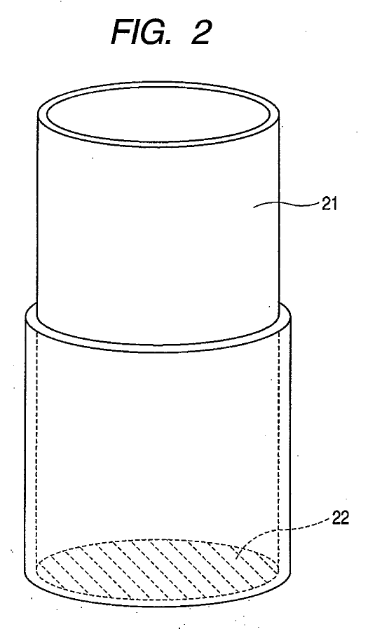

Next, the sensing of a biosubstance using the material of the present invention is described using FIG. 2.

At first, an example of performing avidin-biotin recognition reaction is described.

After modifying the surface of the fine pores of the fine particles of mesoporous silica described earlier, the sites are formed where biotin is fixed on the surface by chemical bonding. Next, the fine particles of mesoporous silica treated in such a way are transferred into a container 21 with a polyethylene filter 22 having fine pores of 0.02 μm diameter installed at the outlet. Then, a dilute solution of streptavidin with a fluorescent tag, which functions as a fluorescent probe, is introduced into the container 21. After a certain period of contact time, excessive streptavidin is removed by filtration using a buffer solution so that only the mesoporous silica particles and the substances bound to them are remained on the filter. Confirming the fluorescence from this filter under a fluorescent microscope means that the detection of streptavidin is achieved using the biotin-fixed mesoporous silica particles.

Next, detection of a biosubstance through antigen-antibody reaction is described.

In this case, the detection is achieved using the composition basically the same as that in the biotin-avidin reaction. At the first step, an antibody or a fragment thereof is immobilized on the surface of fine pores of the mesoporous silica described earlier. In particular, these particles are transferred into the container 21 with the polyethylene filter 22 having fine pores of 0.02 μm diameter installed at the outlet. Then, a solution containing a minute amount of an antibody (biosubstance) is introduced into the container 21. After a certain period of the contact time, the excessive antibody was removed by filtration using a buffer solution. Next, an antigen (biomaterial) with a fluorescent tag beforehand is introduced into the container 21, and after a certain period of the contact time, the particles are washed again using the buffer solution to remove the excessive antigen by filtration. By these operations, only mesoporous silica particles and substances bound to them are remained on the filter. By observing this filter under a fluorescent microscope and by confirming fluorescence, it is confirmed that the specific antigen-antibody reaction is detected using the mesoporous particles.

On fixing an antibody, the direction of the fixed antibody against the opening of the fine pores is an important issue. In these cases, favorable results can be obtained by forming a material, to which the antibody is bound, is formed beforehand on the surface, and then by binding the antibody to that material.

The present invention includes a reaction system that has a reaction site having the functions described above and a biosensing device having a detection system that detects the presence of the target substances. In this case, any reaction system, by which a series of operations described above are carried out, can be used, and any detecting system, that enables the detection of a very small amount of the target biomaterial, can be used. The detection is not limited to the method based on the fluorescence measurement.

The present invention as described above is summarized that using porous particles that have the particle diameter of ten times as the diameter of the fine pores or less, immobilization of the relatively large sized biomaterial becomes possible. By this invention, the immobilized amount per unit volume may be increased, resulting in the production of the biosensing device that can detect selective reactions of biosubstances with high sensitivity.

The present invention will be described below in more details using embodiments, but the present invention is not restricted by the contents of the embodiments.

### EXAMPLE 1

In the present Example, cetyltrimethylammonium chloride as a cationic surfactant, Pluronic F127 triblock copolymer (BASF) as a nonionic surfactant and trimethylbenzene for swelling micelles are used. This is an example in which biotin is bound to the prepared mesoporous particles and streptavidin is detected by fluorometry with high sensitivity.

26.0 g of cetyltrimethylammonium chloride and 20.0 g of F127 were dissolved in 300 g of hydrochloric acid that was adjusted to pH 0.5 beforehand, and 11.0 g of N,N-dimethylhexadecyl amine was added. The mixture was stirred for 4 hours. To this solution, 35.0 g of tetraethoxysilane (TEOS), a silica source, was added and stirred at room temperature for 24 hours to hydrolyze TEOS. To this solution, 30.0 g of 15 M concentrated ammonium hydroxide was added and the solution was further stirred for 24 hours. After drying this solution under vacuum at room temperature for 24 hours, the surfactants were removed by calcining at 540° C. for 10 hours. In this way, mesoporous silica particles were obtained.

The sample after calcination was evaluated using a BET gas adsorption apparatus, and the average fine pore diameter and the specific surface area are estimated to be 5.5 nm and 1100 m²/g, respectively. By observing the sample under a transmission electron microscope (TEM), it was found that this powder has a uniform particle size with an average diameter of 50 nm. Here, the average diameter is estimated by averaging the size of the 20 primary particles that are observed using TEM.

Next, the particles after calcination were treated with aminopropyltriethoxysilane to introduce amino groups on the surface. After this process, the particles were dispersed in a 15 mM DMF solution of biotin-N-hydroxy-succinimide ester, and were subjected to ultrasonic treatment for 10 minutes. After separating from the solution, the particles were thoroughly washed with DMF and ultra pure water in this order, and were dried under a vacuum condition at room temperature.

10 mg of these particles were transferred into the container 21 with an inner diameter of 3 mm, as shown in FIG. 2, with a polyethylene filter 22 having fine pores of 0.02 μm diameter installed at the outlet, and 2.5 μM Cy5 labeled streptavidin solution was introduced. In this step, 0.01 M phosphate buffered saline was used as a solvent.

After introducing the solution to the container and leaving at room temperature for 15 minutes, excess streptavidin was removed by filtration and the particles were washed well with a 0.01 M phosphate buffered saline.

At the last step, the powder on the filter, that underwent these treatments, was observed under a fluorescent microscope. Clear fluorescence was confirmed. These results indicate clearly that streptavidin in a solution can be detected with high sensitivity using the particles of the present invention and the selective reaction between biotin and avidin.

### EXAMPLE 2

Fine particles of mesoporous silica were prepared using the same reagents and conditions as in Example 1.

The fine particles of mesoporous silica were treated with N-trimethoxypropyl-N,N,N-trimethylammonium chloride solution and were washed sufficiently with ethanol.

After drying, these particles were immersed in a saturated solution of tetrachloroaurate (III). Subsequently, they were separated, washed and heated at 200° C. under a hydrogen gas atmosphere for the formation of metallic gold particles in the mesopores. The formation of metallic gold in the fine pores was confirmed by transmission electron microscopy.

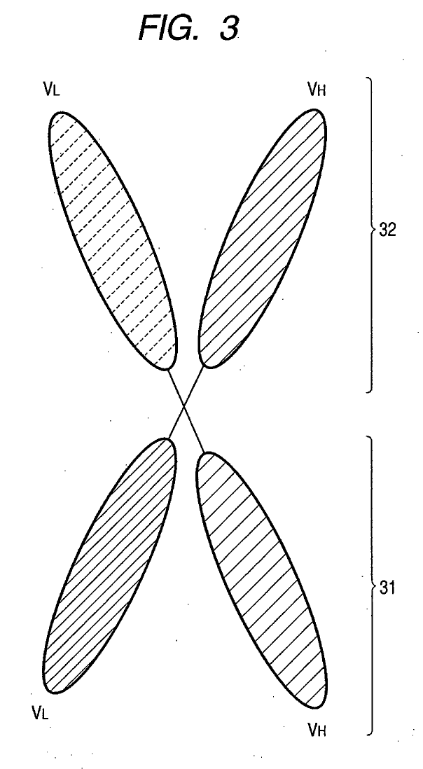

Next, the mesoporous silica particles holding the metallic gold were made contact to a buffer solution containing an artificial antibody having the site with gold affinity to fix the artificial antibody on gold. This artificial antibody was composed of, as shown schematically in FIG. 3, a site 32 that selectively recognizes gold and a site 31 that recognizes hen egg lysozyme (HEL), and these sites were linked together by a single chain Fv. The recognition sites were the variable domain of HEL antibody and the variable domain of the antibody recognizing gold.

The antibody having strong affinity to gold was selected by the screening using the phage display method, and the artificial antibody used in the present embodiment was produced by genetic engineering from this antibody with strong affinity to gold and the anti-HEL antibody.

10 mg of the mesoporous silica particles holding the metallic gold described above was transferred into the container 21 of inner diameter of 3 mm, as shown in FIG. 2, with a polyethylene filter 22 having fine pores of 0.02 μm diameter installed at the outlet. When the solution of the artificial antibody in 0.01 M Phosphate buffered saline was introduced into the container, the artificial antibody was bound through the gold recognition site 32 to fine particles of gold directing the HEL recognition site 31 toward the opening of the fine pores. After keeping in this condition at room temperature for 1 hour, excess artificial antibody was removed by filtration by flowing 0.01M Phosphate buffered saline.

To this mesoporous silica holding the metallic gold and the artificial antibody described above, 1 μM HEL solution was injected to bind the HEL.

Further, 1 μM anti-HEL antibody in 0.01M Phosphate buffered saline was introduced to this and after holding for 1 hour, this was washed well with 0.01M Phosphate buffered saline.

After this, still further 10 μM anti-IgG antibody, to which rhodamine was bound as a fluorescent tag, in 0.01M Phosphate buffered saline solution was introduced. After holding again for 1 hour, this was washed well with 0.01M Phosphate buffered saline.

After these operations, the powder remained on the filter was observed with a fluorescent microscope after drying, and the fluorescence from rhodamine was observed. By these procedures an antigen-antibody reaction can be monitored using the mesoporous silica of the present invention as a carrier of the biomaterials.

### EXAMPLE 3

In this embodiment the biotin-avidin reaction as in Example 1 was detected using a biosensing device consisting of a means of detecting fluorescence and a means of pretreatment of samples.

The biosensing device of the present invention was separated into two major units, a reaction unit and a detection unit.

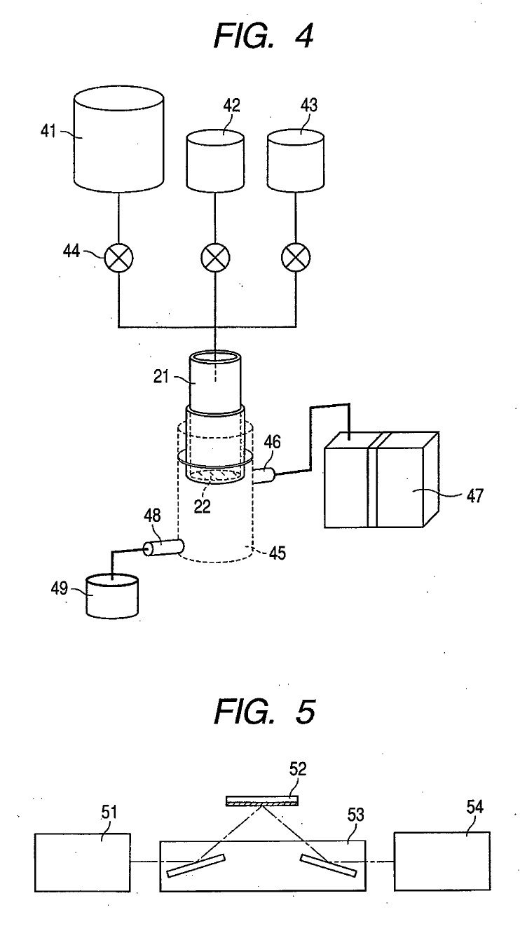

The reaction unit consisted of, as shown in FIG. 4, a vacuum container 45 which held a container 21 and was connected to a vacuum pump 47 through an exhaust outlet 46. It was designed in such a way that solutions are introduced to mesoporous silica powder held on the top of a filter 22, through tubes from a container 41 of a buffer, a container 42 of the solution containing a biosubstance and a container 43 of the solution containing a biomaterial. Tubes were equipped with valves 44 to control the amount of solutions to be introduced. The solution stored on the filter 22 was filtered by the filter 22 by reducing the pressure in the vacuum container 45 and was let out to a waste container 49 from the outlet 48 after stored in 45.

The powder prepared in Example 1, which had been treated with aminopropyl triethoxy silane, and then with biotin-N-hydroxy-succinimide ester, and washed and dried, was placed on the filter 22.

The solution of 2.5 μM streptavidin labeled with Cy5 was placed in the container 43 and introduced on top of the filter by opening the valve. Since the pore size of the filter was so small, the solution remained on the filter unless the pressure in the container was reduced. As in Example 1, after holding the solution for 15 minutes, the pressure in the container was reduced by operating the vacuum pump, and the excess streptavidin was removed by filtration. After this, while maintaining the reduced pressure in the vacuum container, the buffer was introduced from the container 41 to carry out sufficient washing. After washing, the vacuum pump was stopped, and the pressure was returned to the atmospheric pressure, and then the container 21 was taken out and the filter 22, on which mesoporous silica was attached, was removed.

FIG. 5 is a schematic diagram of the detection part. The detection part had basically the same composition as a usual fluorometry equipment. That is, the part was composed of an incident light unit 51, which is composed including a light source and a spectrometer, a jig 52 for fixing the filter, on which fine powder of mesoporous described above was attached, a detection unit 54 including a spectrometer and a detector, and an optical unit 53 composed of a mirror which leads light to the filter and further to the detection part.

The filter treated in the reaction part was illuminated at the detection part with the excitation light, which was monochromated in the incident light unit, and the fluorescent spectra were recorded in the detection system. To detect weak light from the specimen, the detection system was constructed to block the light and in some cases other means such as cooling the detector and the like was provided.

As the results of performing the reaction of Example 1 using this device, clear fluorescent spectra was observed and the selective binding reaction between biotin and avidin could be monitored.

### EXAMPLE 4

In this Example, the same biotin-avidin reaction as in Example 2 was detected using the biosensing device, which is basically the same as in Example 3.

The fine particles of mesoporous silica holding the metallic gold produced in Example 2 were placed on the filter 22 of the device in FIG. 4.

The buffer solution of the artificial antibody having the gold affinity site and HEL affinity site, as described in Example 2, was put in the container 42 and introduced on the filter by opening the valve. Since the pore size of the filter is so small, the solution remained on the filter unless the pressure in the container was reduced. After holding the solution for 15 minutes, the pressure in the container was reduced by operating the vacuum pump and the excess artificial antibody was removed by filtration. After this, while maintaining the reduced pressure in the vacuum container, the buffer was introduced from the container 41 to carry out sufficient washing.

After the vacuum pump was stopped, 1 μM anti-HEL solution in the container 42 was introduced on the filter and held there for 1 hour. And the vacuum pump was turned on again to wash out the excess HEL by the buffer from the container 41.

After stopping the vacuum pump, 1 μM anti-HEL antibody/0.01M Phosphate buffered saline solution was put in the container 42, introduced on the filter 22 and held there for 1 hour. After this, the vacuum pump was turned on again to wash well with 0.01M Phosphate buffered saline.

Finally 10 μM anti IgG antibody bound with rhodamine in 0.01M Phosphate buffered saline in the container 43 was introduced on the filter 22 and held there for 1 hour, and then the filter was washed well by 0.01M Phosphate buffered saline.

After washing, the vacuum pump was stopped, and the pressure was returned to the atmospheric pressure, and then the container 21 was taken out and the filter 22, on which mesoporous silica was attached, was removed.

This filter was fixed to the sample fixing holder in the detection part which had the same composition as in Example 3, and the fluorescent spectra was measured to confirm the fluorescent spectra from rhodamine.

As described above, although the number of the containers is different from that in Example 3, the reaction of Example 2 carried out in the same device produces the results that the target antigen-antibody reaction can be monitored and the antigen can be detected.

The present invention is effective as described above, and is expected to be applicable widely to detection devices for biocatalysts and biosubstances.

This application claims priority from Japanese Patent Application No. 2004-335465 filed on Dec. 8, 2004, which is hereby incorporated by reference herein.

What is claimed is:

1. A particle which comprises mesopores holding a biosubstance, the particle having a diameter ten times or less as large as the diameter of the mesopore.

2. The particle according to claim 1, wherein the particle is composed of silica.

3. The particle according to claim 1, wherein the biosubstance forms a bond with a specific biomaterial.

4. The particle according to claim 3, wherein the bond is formed by an antigen-antibody reaction.

5. The particle according to claim 1, further comprising a material for fixing the biosubstance in the mesopores.

6. A sensor for detecting a substance to be detected, comprising:
a particle according to claim 1; and
a detection part that detects the reaction which is occurred by binding between the substance to be detected and the biosubstance when the reaction occurs.

7. A method for producing a porous structure unit comprising:
a step of preparing an aqueous solution containing a cationic surfactant, a nonionic surfactant, and a hydrophobic material that swells the micelles;
a step of forming a mesostructure of silica having the surfactant and the hydrophobic material by adding a silica source to the aqueous solution;
a step of removing the surfactant and the hydrophobic material from the structure to make the structure hollow; and
a step of immobilizing a biosubstance, which forms a selective bond with a biomaterial to be detected, inside the hollow mesopores in the structure.

8. A method for producing a particle, comprising:
a step of preparing a solution containing a cationic surfactant and a nonionic surfactant;
a step of forming the particle containing the surfactant by adding a silica source to the solution;
a step of forming the particle having mesopores by removing the surfactant from the particle; and
a step of immobilizing a biosubstance in the mesopores.
